(19) United States
(12) Patent Application Publication
(10) Pub. No.: US 2018/0222377 A1
(43) Pub. Date: Aug. 9, 2018

(54) LIGHTING ACCESSORY

(71) Applicant: Earl Bradshaw, West Monroe, LA (US)

(72) Inventor: Earl Bradshaw, West Monroe, LA (US)

(21) Appl. No.: 15/426,270

(22) Filed: Feb. 7, 2017

(51) Int. Cl. B60Q 1/02; F21V 15/01; B60Q 1/00

(52) U.S. Cl. CPC B60Q 1/02; F21Y 2115/10; B60Q 1/0005; F21V 15/01

(57) ABSTRACT

A lighting accessory for an ATV that includes: an outer tube; an inner tube within the outer tube; a light strip within the inner tube; a top cap at a top end of the outer tube; and a base at the bottom of the outer tube. The light strip preferably includes a plurality of LED lights. The base also preferably includes a threaded rod for connecting the lighting accessory to ATV and a heat shrink application surrounding the base. The outer tube includes a polycarbonate material.

### BACKGROUND OF THE INVENTION

### Field of Invention

The present invention relates to a lighting accessory.

### Description of Related Art

All-terrain vehicles (ATV) are well known recreational vehicles that usually include three to four wheels and usually ridden over unpaved terrains. The vehicle is designed to handle many off-road situations due to wheel/tire sizing and wheel base provided. A rider normally sits on the vehicle similar to a motorcycle. However, the wheels provide balance for maneuvering over uneven terrain. Many individuals use these vehicles for recreational and entertainment purposes including night time riding. Night riding requires adequate lighting to safety operate and maneuver the ATV. While the lighting needs to be bright enough to provide visibility for the user and further must be durable to handle weather conditions associated with operating a ATV. As such, a lighting accessory is necessary which can be easily installed on a ATV for nighttime driving.

### SUMMARY OF THE INVENTION

The present invention relates to a lighting accessory for an ATV that includes: an outer tube; an inner tube within the outer tube; a light strip within the inner tube; a top cap at a top end of the outer tube; and a base at the bottom of the outer tube. The light strip preferably includes a plurality of LED lights. The base also preferably includes a threaded rod for connecting the lighting accessory to ATV and a heat shrink application surrounding the base. The outer tube includes a polycarbonate material.

### BRIEF DESCRIPTION OF DRAWINGS

FIG. 1 depicts a lighting accessory in accordance with the present invention.

### DETAILED DESCRIPTION

The present invention relates to a lighting accessory in the form of a whip that is installed on a ATV to provide nighttime lighting. The lighting accessory in accordance with the present invention includes an outer tube, an inner tube within the outer tube and a lighting strip within the inner tube. The outer tubing provides a protective barrier for the lighting strip within the inner tube. The lighting strip within the inner tube includes a plurality LED lights. These LED lights provide sufficient lighting for nighttime riding purposes. Other aspects of the invention include a base and a top cap at opposing ends of the outer tube. Extending from the base is a threaded post for mounting the lighting accessory onto a ATV.

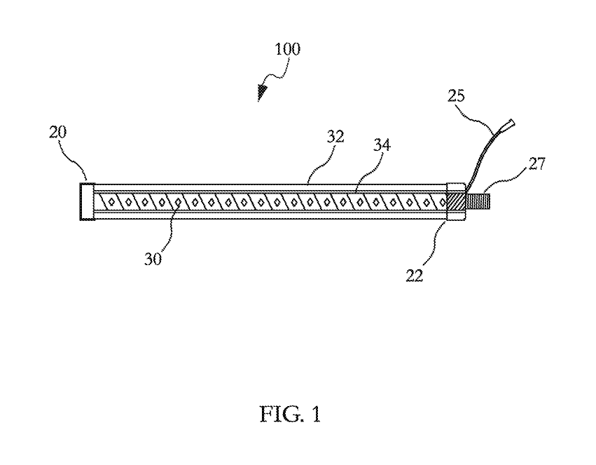

In reference to FIG. 1, a lighting whip 100 is depicted. The lighting whip 100 includes a cylindrical outer tube 32 and a cylindrical inner tube 34 within the outer tube 32. The inner tube 34 includes a lighting strip 30 shown in FIG. 1. The lighting strip 30 preferably includes a plurality of LED lights along the length of the strip 30. A top cap 20 is shown that caps the top portion of the lighting assembly according to present invention. At the opposing end of the outer tube 32 is a base 22. The base 22 further includes a threaded rod 27 that extends from the base 22. The threaded rod 27 provides the means to mount the lighting accessory onto an ATV. Further aspects shown in FIG. 1 is a power cord 25 extending from one end of the outer tubing according to the present invention. The top cap 20 is attached to the top end of the outer tube 32 through the use of epoxy or hot glue. The top cap 20 provides a seal to protect the LED Lighting 30 from weather conditions. Preferably, the outer tube 32 is made of a clear polycarbonate material. The inner tube 34 that includes the lighting strip 30 is preferably made of vinyl. Other aspects of the lighting whip 100 includes the power cord 25 that provides 12-volt power to operate the lighting strip 30. The base 22 includes a heavy gauge heat shrink application to secure the base 22 in place for mounting purposes. The instant invention has been shown and described in what it considers to be the most practical and preferred embodiments. It is recognized, however, that departures may be made there from within the scope of the invention and that obvious modifications will occur to a person skilled in the art.

What is claimed is:

1. A lighting accessory for an all terrain vehicle comprising:
a. an outer tube;
b. an inner tube within the outer tube;
c. a light strip within the inner tube;
d. a top cap at a top end of the outer tube; and
e. a base at the bottom of the outer tube.

2. The lighting accessory according to claim 1, where the light strip includes a plurality of LED lights.

3. The lighting accessory according to claim 1, where the base includes a threaded rod.

4. The lighting accessory according to claim 1, where the base includes a heat shrink application.

5. The lighting accessory according to claim 1, where the outer tube includes a polycarbonate material.
